(19) United States
(12) Patent Application Publication
(10) Pub. No.: US 2024/0153396 A1
(43) Pub. Date: May 9, 2024

(54) LANGUAGE LEARNING

(71) Applicant: THE NONSENSE COMPANY, INC., Salt Lake City, UT (US)

(72) Inventors: TYLER SLATER, Cottonwood Heights, UT (US); JORDAN ELLETT, Mapleton, UT (US); TRAVIS NUTTALL, Saratoga Springs, UT (US); ARIANNA Soltys, Woodinville, WA (US); NICK HATHAWAY, Brooklyn, NY (US)

(73) Assignee: THE NONSENSE COMPANY, INC., Salt Lake City, UT (US)

(21) Appl. No.: 18/504,880

(22) Filed: Nov. 8, 2023

Related U.S. Application Data
(60) Provisional application No. 63/423,605, filed on Nov. 8, 2022.

(51) Int. Cl. G09B 5/06; G06F 40/47; G09B 19/06; G10L 15/06; G10L 15/16; G10L 15/19; G10L 15/30

(52) U.S. Cl. CPC G09B 5/065; G06F 40/47; G09B 19/06; G10L 15/063; G10L 15/16; G10L 15/19; G10L 15/30

(57) ABSTRACT

Apparatuses, methods, systems, and program products are disclosed for language learning. An apparatus includes a processor and a memory that stores code executable by the processor to present a multimedia clip comprising an audio stream that is presented in a first language, receive a transcription of the audio stream in a second language different from the first language, determine one or more linguistic constructions of the received transcription that are being learned, and present at least a portion of the received transcription during playback of the multimedia clip with one or more portions of the presented transcription highlighted to emphasize the one or more linguistic constructions that are being learned.

### CROSS REFERENCE TO RELATED APPLICATIONS

This application claims the benefit of U.S. Provisional Patent Application No. 63/423,605 entitled “LANGUAGE LEARNING” and filed on Nov. 8, 2022, for Tyler Slater, et al., which is incorporated herein by reference.

### FIELD

This invention relates to language learning and more particularly relates to an artificial intelligence-based linguistic construction indexer for indexing language in media content.

### BACKGROUND

Learning a new language requires learning in context through mass exposure to real world language. Obtaining sufficient real-world exposure is difficult.

### BRIEF SUMMARY

Apparatuses, methods, systems, and program products are disclosed for language learning. In one embodiment, an apparatus includes a processor and a memory that stores code executable by the processor to present a multimedia clip comprising an audio stream that is presented in a first language, receive a transcription of the audio stream in a second language different from the first language, determine one or more linguistic constructions of the received transcription that are being learned, and present at least a portion of the received transcription during playback of the multimedia clip with one or more portions of the presented transcription highlighted to emphasize the one or more linguistic constructions that are being learned.

In one embodiment, a method includes presenting a multimedia clip comprising an audio stream that is presented in a first language, receiving a transcription of the audio stream in a second language different from the first language, determining one or more linguistic constructions of the received transcription that are being learned, and presenting at least a portion of the received transcription during playback of the multimedia clip with one or more portions of the presented transcription highlighted to emphasize the one or more linguistic constructions that are being learned.

In one embodiment, an apparatus includes means for presenting a multimedia clip comprising an audio stream that is presented in a first language, means for receiving a transcription of the audio stream in a second language different from the first language, means for determining one or more linguistic constructions of the received transcription that are being learned, and means for presenting at least a portion of the received transcription during playback of the multimedia clip with one or more portions of the presented transcription highlighted to emphasize the one or more linguistic constructions that are being learned.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for language learning in accordance with the subject matter described herein;

FIG. 2 is a schematic block diagram illustrating one embodiment of an apparatus for language learning in accordance with the subject matter described herein;

FIG. 3 is a schematic block diagram illustrating one embodiment of a method for language learning in accordance with the subject matter described herein;

FIG. 4A is an example interface for language learning in accordance with the subject matter described herein;

FIG. 4B is an example interface for language learning in accordance with the subject matter described herein;

FIG. 4C is an example interface for language learning in accordance with the subject matter described herein; and

FIG. 4D is an example interface for language learning in accordance with the subject matter described herein.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, to more particularly emphasize their implementation independence. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (“ISA”) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider). In some embodiments, electronic circuitry including, for example, programmable logic circuitry, field-programmable gate arrays (“FPGA”), or programmable logic arrays (“PLA”) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Many of the functional units described in this specification have been labeled as modules, to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program instructions may, for instance, comprise one or more physical or logical blocks of computer instructions which may, for instance, be organized as an object, procedure, or function. Nevertheless, the executables of an identified module need not be physically located together but may comprise disparate instructions stored in different locations which, when joined logically together, comprise the module and achieve the stated purpose for the module.

The schematic flowchart diagrams and/or schematic block diagrams in the Figures illustrate the architecture, functionality, and operation of possible implementations of apparatuses, systems, methods, and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

As discussed in more detail below, the subject matter described herein is directed to using artificial intelligence (“AI”), and in particular machine learning, to develop a language analysis pipeline for learning a language.

As used herein, AI may refer to a broadly defined branch of computer science dealing in automating intelligent behavior. AI systems may be designed to use machines to emulate and simulate human intelligence and corresponding behavior. This may take many forms, including symbolic or symbol manipulation AI. AI may address analyzing abstract symbols and/or human readable symbols. AI may form abstract connections between data or other information or stimuli. AI may form logical conclusions. AI is the intelligence exhibited by machines, programs, or software. AI has been defined as the study and design of intelligent agents, in which an intelligent agent is a system that perceives its environment and takes actions that maximize its chances of success.

AI may have various attributes such as deduction, reasoning, and problem solving. AI may include knowledge representation or learning. AI systems may perform natural language processing, perception, motion detection, and information manipulation. At higher levels of abstraction, it may result in social intelligence, creativity, and general intelligence. Various approaches are employed including cybernetics and brain simulation, symbolic, sub-symbolic, and statistical, as well as integrating the approaches.

Various AI tools may be employed, either alone or in combinations. The tools may include search and optimization, logic, probabilistic methods for uncertain reasoning, classifiers and statistical learning methods, neural networks, deep feedforward neural networks, deep recurrent neural networks, deep learning, control theory and languages.

Machine learning (“ML”) plays an important role in a wide range of critical applications with large volumes of data, such as data mining, natural language processing, image recognition, voice recognition and many other intelligent systems. There are some basic common threads about the definition of ML. As used herein, ML is defined as the field of study that gives computers the ability to learn without being explicitly programmed. For example, predicting traffic patterns at a busy intersection, it is possible to run through a machine learning algorithm with data about past traffic patterns. The program can correctly predict future traffic patterns if it learned correctly from past patterns.

There are different ways an algorithm can model a problem based on its interaction with the experience, environment, or input data. The machine learning algorithms may be categorized so that it helps to think about the roles of the input data and the model preparation process leading to correct selection of the most appropriate category for a problem to get the best result. Known categories are supervised learning, unsupervised learning, semi-supervised learning, and reinforcement learning.
(a) In supervised learning category, input data is called training data and has a known label or result. A model is prepared through a training process where it is required to make predictions and is corrected when those predictions are wrong. The training process continues until the model achieves a desired level of accuracy on the training data. Example problems are classification and regression.
(b) In unsupervised learning category, input data is not labelled and does not have a known result. A model is prepared by deducing structures present in the input data. Example problems are association rule learning and clustering. An example algorithm is k-means clustering.
(c) Semi-supervised learning falls between unsupervised learning (without any labeled training data) and supervised learning (with completely labeled training data). Researchers found that unlabeled data, when used in conjunction with a small amount of labeled data may produce considerable improvement in learning accuracy.
(d) Reinforcement learning is another category which differs from standard supervised learning in that correct input/output pairs are never presented. Further, there is a focus on on-line performance, which involves finding a balance between exploration for new knowledge and exploitation of current knowledge already discovered.

Certain machine learning techniques are widely used and are as follows: Decision tree learning, Association rule learning, Artificial neural networks, Inductive logic programming, Support vector machines, Clustering, Bayesian networks, Reinforcement learning, Representation learning, and Genetic algorithms.

The learning processes in machine learning algorithms are generalizations from past experiences. After having experienced a learning data set, the generalization process is the ability of a machine learning algorithm to accurately execute on new examples and tasks. The learner needs to build a general model about a problem space enabling a machine learning algorithm to produce sufficiently accurate predictions in future cases. The training examples come from some generally unknown probability distribution.

In theoretical computer science, computational learning theory performs computational analysis of machine learning algorithms and their performance. The training data set is limited in size and may not capture all forms of distributions in future data sets. The performance is represented by probabilistic bounds. Errors in generalization are quantified by bias-variance decompositions. The time complexity and feasibility of learning in computational learning theory describes a computation to be feasible if it is done in polynomial time. Positive results are determined and classified when a certain class of functions can be learned in polynomial time whereas negative results are determined and classified when learning cannot be done in polynomial time.

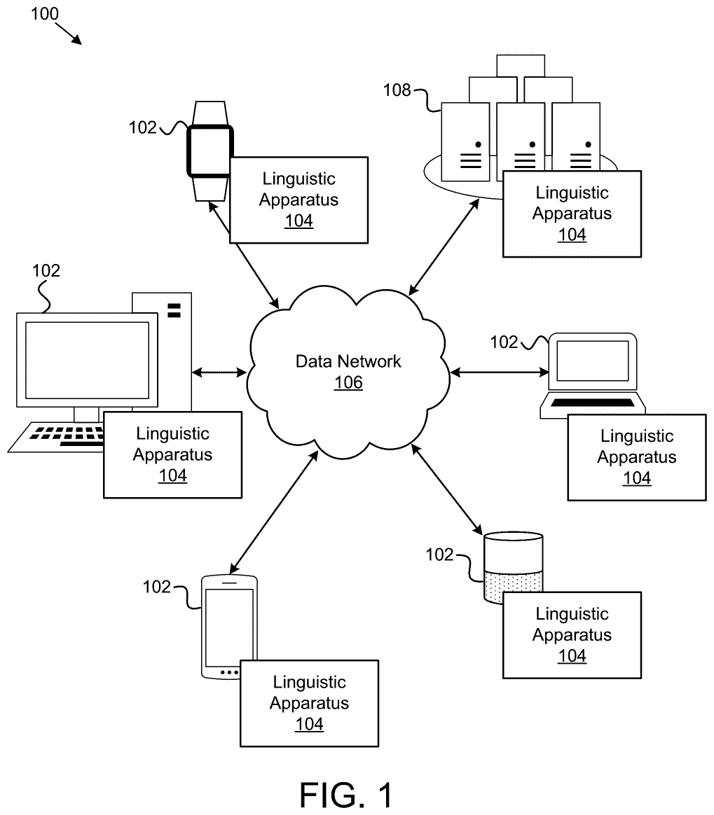

FIG. 1 is a schematic block diagram illustrating one embodiment of a system 100 for language learning. In one embodiment, the system 100 includes one or more information handling devices 102, one or more linguistic apparatuses 104, one or more data networks 106, and one or more servers 108. In certain embodiments, even though a specific number of information handling devices 102, linguistic apparatuses 104, data networks 106, and servers 108 are depicted in FIG. 1, one of skill in the art will recognize, in light of this disclosure, that any number of information handling devices 102, linguistic apparatuses 104, data networks 106, and servers 108 may be included in the system 100.

In one embodiment, the information handling devices 102 may include one or more of a desktop computer, a laptop computer, a tablet computer, a smart phone, a smart speaker (e.g., Amazon Echo®, Google Home®, Apple HomePod®), a security system, a set-top box, a gaming console, a smart TV, a smart watch, a fitness band or other wearable activity tracking device, an optical head-mounted display (e.g., a virtual reality headset, smart glasses, or the like), a High-Definition Multimedia Interface (“HDMI”) or other electronic display dongle, a personal digital assistant, a digital camera, a video camera, or another computing device comprising a processor (e.g., a central processing unit (“CPU”), a processor core, a field programmable gate array (“FPGA”) or other programmable logic, an application specific integrated circuit (“ASIC”), a controller, a microcontroller, and/or another semiconductor integrated circuit device), a volatile memory, and/or a non-volatile storage medium.

In certain embodiments, the information handling devices 102 are communicatively coupled to one or more other information handling devices 102 and/or to one or more servers 108 over a data network 106, described below. The information handling devices 102, in a further embodiment, may include processors, processor cores, and/or the like that are configured to execute various programs, program code, applications, instructions, functions, and/or the like for processing text, executing machine learning and/or artificial intelligence models, sending electronic messages, displaying information in one or more graphical formats on a graphical user interface, connecting to a network such as the Internet to access social media sites and other websites that includes publicly available information, and/or the like.

In general, learning a new language requires learning in context through mass exposure to real world language. Obtaining sufficient real-world exposure may be difficult. The linguistic apparatus 104 is configured to provide an artificial intelligence-based system that understands and indexes language in multimedia content to an unprecedented level of depth and accuracy. This linguistic apparatus 104, in one embodiment, provides learners with an experience equivalent to a trained linguist and language teacher breaking down linguistic constructions (e.g. words, grammar patterns, idiomatic expressions) and explaining them in how they are used in the specific context of the media. Additionally, the indexed nature of the data makes it easy for users to find additional examples of specific uses of those exact same constructions. The linguistic apparatus 104, including its various sub-modules, may be located on one or more information handling devices 102 in the system 100, one or more servers 108, one or more network devices, and/or the like. Because the subject matter disclosed herein is automated, it can be used on any and all language content with a text source. This includes both popular media, for emotional impact and better memory retention, or domain-specific (medical, military, etc.) content for enterprise applications.

In various embodiments, the linguistic apparatus 104 may be embodied as a hardware appliance that can be installed or deployed on an information handling device 102, on a server 108, or elsewhere on the data network 106. In certain embodiments, the linguistic apparatus 104 may include a hardware device such as a secure hardware dongle or other hardware appliance device (e.g., a set-top box, a network appliance, or the like) that attaches to a device such as a laptop computer, a server 108, a tablet computer, a smart phone, a security system, or the like, either by a wired connection (e.g., a universal serial bus (“USB”) connection) or a wireless connection (e.g., Bluetooth®, Wi-Fi, near-field communication (“NFC”), or the like); that attaches to an electronic display device (e.g., a television or monitor using an HDMI port, a DisplayPort port, a Mini DisplayPort port, VGA port, DVI port, or the like); and/or the like. A hardware appliance of the linguistic apparatus 104 may include a power interface, a wired and/or wireless network interface, a graphical interface that attaches to a display, and/or a semiconductor integrated circuit device as described below, configured to perform the functions described herein with regard to the linguistic apparatus 104.

The linguistic apparatus 104, in such an embodiment, may include a semiconductor integrated circuit device (e.g., one or more chips, die, or other discrete logic hardware), or the like, such as a field-programmable gate array (“FPGA”) or other programmable logic, firmware for an FPGA or other programmable logic, microcode for execution on a microcontroller, an application-specific integrated circuit (“ASIC”), a processor, a processor core, or the like. In one embodiment, the linguistic apparatus 104 may be mounted on a printed circuit board with one or more electrical lines or connections (e.g., to volatile memory, a non-volatile storage medium, a network interface, a peripheral device, a graphical/display interface, or the like). The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of the linguistic apparatus 104.

The semiconductor integrated circuit device or other hardware appliance of the linguistic apparatus 104, in certain embodiments, includes and/or is communicatively coupled to one or more volatile memory media, which may include but is not limited to random access memory (“RAM”), dynamic RAM (“DRAM”), cache, or the like. In one embodiment, the semiconductor integrated circuit device or other hardware appliance of the linguistic apparatus 104 includes and/or is communicatively coupled to one or more non-volatile memory media, which may include but is not limited to: NAND flash memory, NOR flash memory, nano random access memory (nano RAM or “NRAM”), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a wide area network (“WAN”), a storage area network (“SAN”), a local area network (“LAN”), an optical fiber network, the internet, or other digital communication network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a Bluetooth® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (ASTM®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT-F® connection as defined by Dynastream® Innovations Inc. of Cochrane, Canada. The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

The one or more servers 108, in one embodiment, may be embodied as blade servers, mainframe servers, tower servers, rack servers, and/or the like. The one or more servers 108 may be configured as mail servers, web servers, application servers, FTP servers, media servers, data servers, web servers, file servers, virtual servers, and/or the like. The servers 108 may be configured or optimized for executing machine learning algorithms one a single server 108 or using a distributed or cluster architecture that employs a plurality of servers 108. The servers 108 may be located in a data center or in different geographical locations that are accessible to one or more other servers 108 or information handling devices 102 via a data network 106 or the “cloud.”

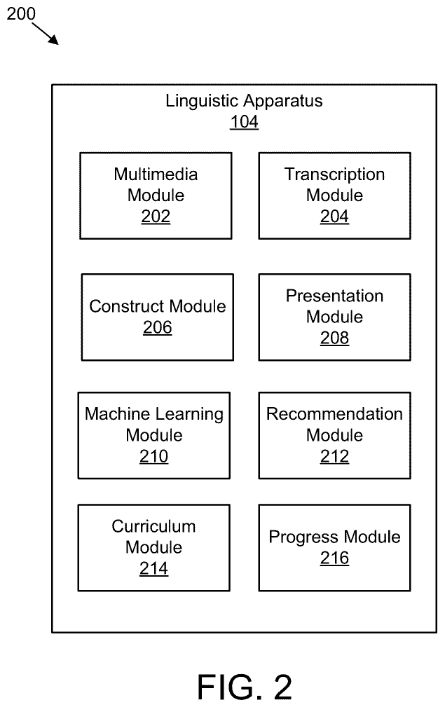

FIG. 2 depicts one embodiment of an apparatus for language learning. In one embodiment, the apparatus 200 includes an embodiment of a linguistic apparatus 104. In one embodiment, the linguistic apparatus 200 includes one or more instances of a multimedia module 202, a transcription module 204, a construct module 206, and a presentation module 208, which are described in more detail below.

In one embodiment, the multimedia module 202 is configured to present a multimedia clip comprising an audio stream that is presented in a first language. In one embodiment, the multimedia clip includes a video clip, snippet, trailer, movie, reel, or the like that includes a corresponding audio stream, e.g., music, dialogue, conversation, narration, or the like. In one embodiment, the multimedia clip includes clips of popular movies or television shows. The audio stream that is associated with the multimedia clip may be presented, dubbed, recorded, or the like in one or more languages such as English, Spanish, French, Chinese, or the like.

In one embodiment, the multimedia module 202 accesses the multimedia clip from a local data store, a remote data store, and/or the like via an interface such as a web browser, an application programming interface (“API”), a network interface, a serial interface, and/or the like.

In one embodiment, the multimedia module 202 selects the multimedia clip based on one or more linguistic constructions that are being learned. The linguistic constructions, for instance, may include morphology-based constructions, syntactic relation-based constructions, conjugation characteristics, parts of speech, alternatives, grammar usage, exclamatives, imperatives, and/or the like. In such an embodiment, the multimedia clip may be pre-processed and indexed to flag, mark, or otherwise indicate movie clips that contain audio streams that include audio illustrating usage of one or more different parts of speech. The multimedia module 202 may then search by linguistic construction, by keyword, or the like for multimedia clips that include an example of usage of a particular linguistic construction.

In one embodiment, the transcription module 204 is configured to receive a transcription of the audio stream in a second language that is different from the first language. In one embodiment, the transcription module 204 selects a transcription from a plurality of transcriptions for different languages associated with the multimedia clip based on the desired language that is being learned (and further based on the linguistic construct(s) of the second language that is being learned). In another embodiment, the transcription module 204 transcribes the audio clip in the first language to a text transcription in the second language in real-time, on the fly, or the like. For instance, the transcription module 204 may transcribe an English audio stream for a movie clip into a translated and transcribed text version of the English audio in a different language such as Spanish or French.

In one embodiment, the construct module 206 is configured to determine one or more linguistic constructions of the received transcription that are being learned. In one embodiment, the one or more linguistic constructions are selected from the group comprising morphology-based constructions, syntactic relation-based constructions, conjugation characteristics, parts of speech, alternatives, or a combination of the foregoing.

In one embodiment, the construct module 206 utilizes a language analysis pipeline (e.g., a machine learning pipeline that codifies and automates the workflow it takes to produce a machine learning model. Machine learning pipelines may consist of multiple sequential steps that do everything from data extraction and preprocessing to model training and deployment) that provides accurate and comprehensive morphosyntactic data in raw form. In one embodiment, the construct module 206 provides language media content, such as an audio stream, a transcription of an audio stream, and/or the like, to the language analysis pipeline, which outputs low-level morphological and syntactic data including lemmas, part of speech tags, morphological feature tags, and dependency relations. In one embodiment, the construct module 206 trains and/or utilizes machine learning models, e.g., language models that can process common linguistic constructions that occur in conversational speech (e.g., first and second person conjugations, subjunctive conjugations, exclamatives and imperatives, or the like by tuning or refining the models using target data, as well as knowledge-based post-processing using dictionaries and other methods.

In one embodiment, the construct module 206 uses a linguistic construct query to determine one or more linguistic constructions that are being learned and the associated multimedia clips that illustrate usage of the one or more linguistic constructions. In one embodiment, the linguistic construct query acts upon one or more database structures to identify the one or more linguistic constructions that are being learned and the associated multimedia clips.

In one embodiment, the construct module 206 uses a custom construction query language (“CQL”) to define pedagogically relevant linguistic constructions in terms of their lemmas, parts of speech, morphological features, and syntactic relationships. In one embodiment, the CQL language supports recursive operations, allowing for deep nesting of relations. The CQL also supports complex filtering and allows for labeling of individual components of the result.

In one embodiment, the CQL is strongly typed, which allows for statically identifying syntactic and labeling errors in CQL queries. In one embodiment, the construct module 206 provides an integrated development environment (“IDE”) with autocompletion, embedded documentation, and error checking, which allows for accurate, low-effort query writing, with minimal training to interface with more complicated underlying computing.

In one embodiment, CQL queries allow for comprehensive labeling of pedagogically relevant linguistic constructions in arbitrary media. This occurs, in practice, using a CQL query engine, which parses language queries and targets language content in an efficient manner, automatically labeling components of the CQL query constructions. In one embodiment, the functionality is bidirectional. When new media is added to a content library, e.g., a multimedia database, it is analyzed across all CQL queries and labeled accordingly. Conversely, when a new query is added, existing multimedia is automatically compared against that query. When a new query is updated, old labels are idempotently updated. In one embodiment, updates preserve identity across queries, construction components, and labels to retain user activity and progress information across constructions.

In addition to writing queries, the construct module 206 allows users, such as linguists and/or instructors, to write plain language explanations of the grammar that the construct module 206 dynamically adapts to the context of the target language media. This may happen through the query results and accompanying labels. The construct module 206, in one embodiment, generates explanations as templates that reference the query labels. The explanations may also contain conditional logic for complex adaptation and dynamic explanations. Further, the explanations may include the option of using query component colors and arbitrary coloring to match components, part of speech, or highlight arbitrary patterns, e.g., when presented in a graphical user interface.

In one embodiment, the number of linguistic constructions in any individual language is intractable to label by hand. For multi-word expressions, for instance, dictionary data may be used to identify multi-word expressions in the target language. The language analysis pipeline may then be run on the multi-word expression. The analysis output may be combined with knowledge of placeholder words (e.g., “one's”, “someone's”, “somebody”, “someplace”, “somewhere”, or the like) to automatically create a CQL query, accompanying construction name and component labels, and template explanations.

In one embodiment, the construct module 206 stores the CQL query results as labeled components, with text offsets, part of speech indicators, and coloring information. Constructions are indexed in language-specific collations for rapid lookup of linguistic construction examples. Searches may be performed using source target text, linguistic construction name, or linguistic construction identity (e.g., more examples of a specific conjugation).

In one embodiment, the custom CQL allows the construct module 206 to statically define pedagogically relevant language constructions. The construct module 206 can find and tag instances of linguistic constructions, as defined by a combination of morphological features and/or syntactic relations, which eliminates the need for hand-annotation, cutting down significantly on the labor and resources that would typically go into creating engaging language learning content. Paired together with media content that has been proven to capture users' attention, the AI-powered language explanations disclosed herein can facilitate the language learning process.

In one embodiment, the CQL provides the ability to establish search criteria based on simple combinations of linguistic features using a custom Domain Specific Language (“DSL”) built on structured query language (“SQL”). In one embodiment, the CQL may provide additional language features and complex functions such as recursive searching, exclusion based on unique combinations of feature, and/or the like.

In one example embodiment, the construct module 206 may generate Multi-Word Expressions (“MWEs”) using multilingual dictionary data, e.g., Wiktionary data. Essentially, the construct module 206 extracts entries from Wiktionary that contain more than one word, runs the parser on the phrase, and uses the resulting information to automatically generate the components of the query required to find it. In one embodiment, the query is generated using dependency parse labels, which have a higher likelihood of capturing expressions that have more syntactic flexibility, e.g., less rigidity in word order and/or other words appearing between components of the expression. In another embodiment, the query is generated using a system of neighbors, e.g., identifying the expression through a more simplistic series of tokens, which allows for less flexibility with syntax but has a higher likelihood of finding instances of the expression when the dependency relations are more variable.

In one embodiment, the construct module 206 establishes a custom context-adapted explanation template generator. In such an embodiment, the construct module 206, using newly defined linguistic constructions, creates a mechanism for attaching context-adapted explanations onto instances of each linguistic construction. This allows the linguistic apparatus 104 to create a user experience in which each piece of media content has been enhanced with explanations beyond simple dictionary entries. Users will be able to see explanations for variations in form, and for idiomatic meaning derived from combinations of words. Dictionary entries often display definitions by lemma (the uninflected base form of a word), or linguistic jargon such as “second person singular form of [the lemma],” which is less than helpful for a casual learner without meta-linguistic knowledge. The linguistic apparatus 104 facilitates anxiety-free language learning, so it is important to attach custom, context-based explanations to each construction, to avoid confusion and the resultant affective filter. In one embodiment, the construct module 206 automates generation of the explanation template such that it is written once for the grammar pattern and adapted automatically by filling in the specific words from the sentence it is tagged onto in each instance.

In one embodiment, the presentation module 208 is configured to present at least a portion of the received transcription during playback of the multimedia clip with one or more portions of the presented transcription highlighted or colored to emphasize the one or more linguistic constructions that are being learned. In one embodiment, the presentation module 208 is configured to present additional information associated with at least one of the one or more highlighted portions of the presented transcription in response to user input.

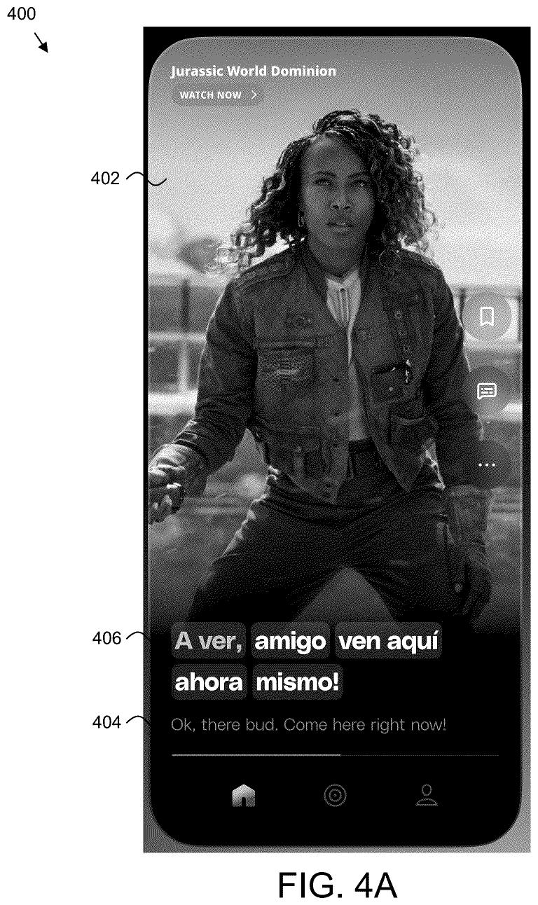

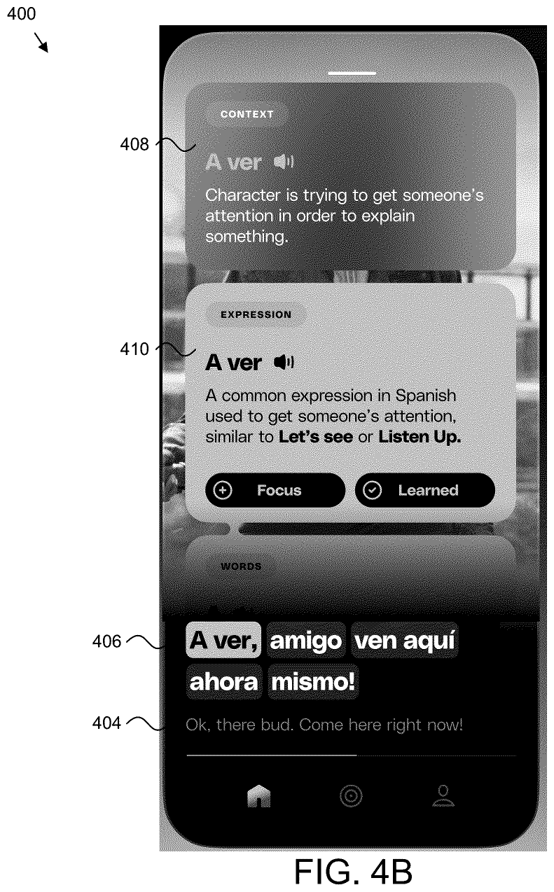

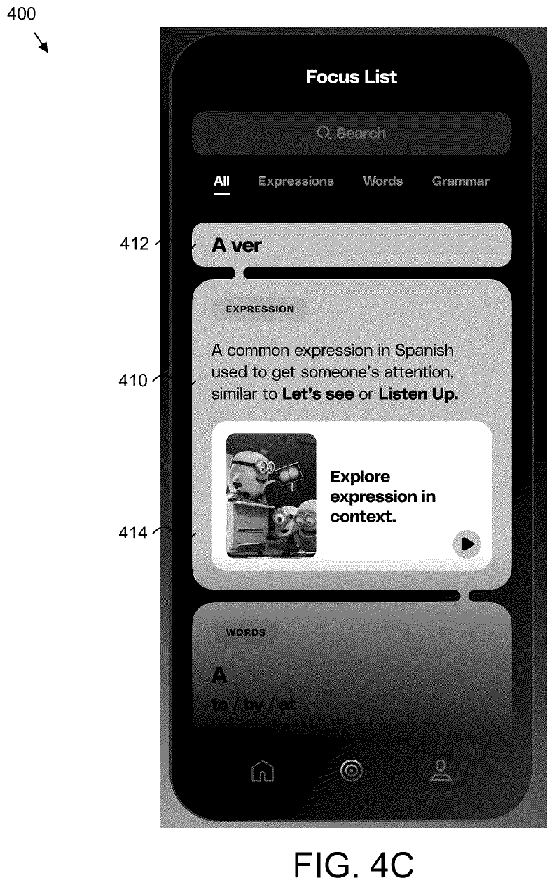

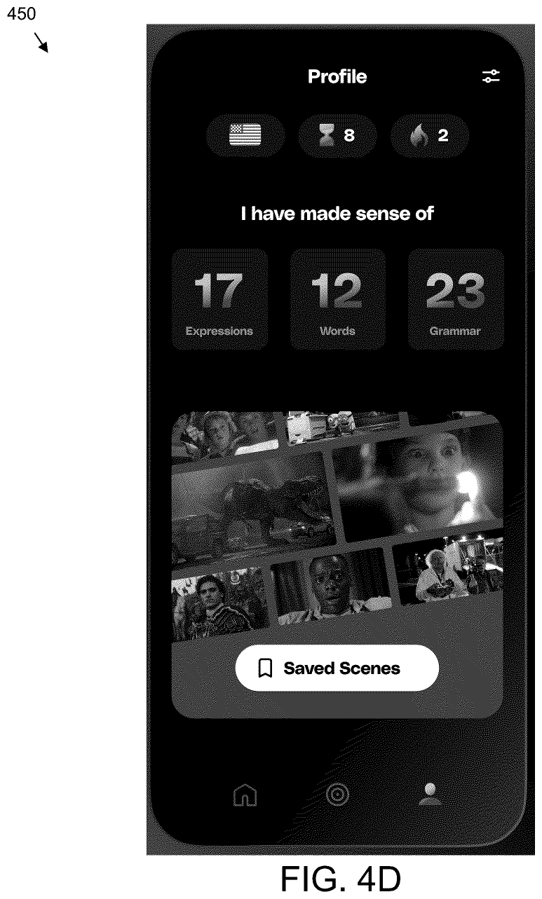

When viewing media, for instance, the presentation module 208 presents users with smart subtitles, e.g., marked-up, interactive transcriptions of the audio stream presented in a different language than the audio stream (as shown in FIGS. 4A-4D). In one embodiment, the presentation module 208 receives a selection (e.g., press, tap, click, or the like) of any word (or a portion of a word), sentence, phrase, or the like, that is presented as part of the subtitles and displays associated semantic information about that word (or a portion of a word), sentence, phrase, or the like. In one embodiment, the presentation module 208 also presents a templated explanation, illuminating and color coding patterns, using words from the original context to make the explanation simpler and more concrete. In one embodiment, the presentation module 208 also presents the user with the option to view more examples of a given construction in their target language in additional media. Finally, users can subjectively rate their understanding and familiarity with the construction.

In one embodiment, the machine learning module 210 uses a machine learning model to process the linguistic construct query to identify the one or more linguistic constructions that are being learned. In one embodiment, the machine learning model includes a neural network model. In one embodiment, the machine learning module 210 initially trains the machine learning model using referential sources and further refines the machine learning model using knowledge-based post-processing sources.

In one embodiment, the machine learning module 210 employs multilingual, multitask neural network models capable of predicting universal parts of speech, lemmas, morphological features, and dependency parse trees. In one embodiment, the machine learning module 210 may utilize a dependency grammar framework due to its system of heads/dependents that is resilient to syntactically flexible languages.

In one embodiment, the machine learning module 210 transforms the different layers of linguistic analysis into a “grammar search engine,” in which combinations of features are encoded into definitions of linguistic constructions that the construct module 206 uses to find and tag instances of pedagogically-relevant constructions, including but not limited to conjugation, declension patterns, and idiomatic expressions. In one embodiment, this allows the presentation module 208 to automate the transformation of media content into engaging language learning materials and create an immersive experience for the learner in which second language acquisition takes place in an engaging, meaningful context.

In one embodiment, the machine learning module 210 improves scores for Lemmatization (LEM), Universal Part of Speech-tagging (UPOS), Labeled Attachment Score (LAS) (e.g., the percentage of words that are assigned both the correct syntactic head and the correct dependency label), and Unlabeled Attachment Score (UAS) (e.g., the percentage of words that are assigned the correct head, without taking into account dependents). These metrics are standard in dependency parser evaluation.

In one embodiment, the presentation module 208 provides an interface, e.g., a web interface that can display comparisons of the output of each dependency parser. In such an embodiment, a user, the machine learning module 210, and/or the like, may analyze the comparison of the different dependency parsers to determine which model produces the best initial (prior to retraining) results. In one embodiment, the machine learning module 210 runs tests on a corpus, or a subset of the corpus, and selects the model that can produce the highest scores.

In one embodiment, the machine learning module 210 converts the analyzer system (which may be composed of tokenization, lemmatization, POS-tagging, morphological analyzer, and dependency parsing) to a pipeline and includes knowledge-based improvements. In such an embodiment, the machine learning module 210 updates or refines the language analysis pipeline to include knowledge-based post-processing corrections. For example, the stages in the analyzer pipeline that run linguistic analysis may rely on predictive models that have been trained on over 150 multilingual treebanks, without reference to any sort of knowledge-based awareness. The result may be a high level of adaptability when it comes to learning patterns, especially with un-encountered, low-resource languages, but it is missing the “common sense” of what would constitute a reasonable value to fill each respective field. For example, the lemmatization produced by conventional systems, such as Udify, is prone to the error of “nonsense” words.

In one embodiment, the machine learning module 210 addresses these errors by introducing post-processing corrections into the language processing pipeline. In such an embodiment, the machine learning module 210 pulls this knowledge from a plurality of different sources and evaluates which produces the most accurate corrections. These sources may include, for example, online sources such as Wiktionary, FreeDict, and Open Multilingual Wordnet, as well as language-specific dictionaries. In one embodiment, the machine learning module 210 provides a system, interface, or the like that allows for manual edits to the parser output, to resolve low frequency/consistency mistakes, which may be resistant to the automatic updates when transcripts are edited, or new queries are written or edited.

In one embodiment, the machine learning module 210 determines the ideal analyzer pipeline to achieve equivalent accuracy scores with the audio stream, e.g., television and movie dialogue dataset, as with the Universal Dependencies treebanks composed of newspaper and other text-based corpora. In one embodiment, the machine learning module 210 improves the accuracy of the established pipeline by retraining the selected model on a dataset congruent with conversational language.

In one embodiment, the machine learning module 210 retrains the model on the custom dataset (e.g., the dataset that is more pertinent to conversational language) to improve the accuracy of the parser. In such an embodiment, the machine learning module 210 uses or creates testing and training datasets, which include annotations to ensure correct labels for training. In another embodiment, the machine learning module 210 isolates a subset of the dataset to use for evaluation, e.g., to evaluate improvements in scores for LEM, UPOS, LAS, and UAS by comparing each feature tag and head/dependent relationship with a standard. In one embodiment, the machine learning module 210 provides a language analysis pipeline that is applicable to various languages and their respective linguistic constructions.

In one embodiment, because language learners experience authentic language in context, and supported by the layer of automatically-tagged explanations, accurate linguistic analysis is paramount. Conventional language analyzers suffer from poor performance on datasets of television and movie dialogue (and other examples of real world language usage), with predictive rates as low as 70% (this is quite a large range that varies by language and by feature tag). Furthermore, low performance in instances of conversational speech that rarely appear in corpora of written texts, such as second-person, subjunctive, exclamatives, and imperatives have been identified. For example, conventional systems nearly universally mis-label instances of the second-person singular present subjunctive as Mood=IND (indicative, when it should be tagged as SUB (subjunctive)), in Spanish. Similarly, conventional parsers struggle to accurately predict the correct value to fill the Aspect field, with perfective (PERF) or imperfective (IMP), in Russian.

To remedy the shortcomings of the existing solutions, the machine learning module 210, in one embodiment, evaluates the performance of a plurality of different language parsers and selects the model with the highest accuracy scores. Further, the machine learning module 210, in one embodiment, converts the analyzer model to a pipeline that includes knowledge-based post-processing corrections. In addition, in one embodiment, the machine learning module 210 retrains the selected model with a custom dataset, so it can learn from more relevant examples.

In one embodiment, a recommendation module 212 is configured to determine recommendations for one or more of a linguistic construction to learn and a multimedia clip to present. In one embodiment, based on user interactions with language (both explicit and implicit), the recommendation module 212 provides recommendations in the form of language highlighting and assessments in an interface. Interactions can include pressing, tapping, or selecting words (or sentence regions), subjective ratings, assessment performance on constructions, lack of interaction, or speaking performance. These behavioral inputs may be combined with standard spaced repetition algorithms to draw learner attention to linguistic constructions as they consume additional media in an optimized way.

In one embodiment, because the construct module 206 has indexed all of the linguistic constructions in every piece of content and has collected both behavioral and explicit subjective user data on linguistic constructions, the recommendation module 212 can combine those data sets to recommend content that is optimal for learning. The recommendation module 212 may use a combination of heuristics and machine learning techniques with the data as input in order to prioritize content to recommend to users.

In one embodiment, the curriculum module 214 provides a curriculum alignment tool. For instance, for students enrolled in scholastic or test preparation courses, the curriculum alignment tool allows either students or instructors to statically define linguistic constructions (vocabulary, grammar, multi-word/idiomatic expressions, or the like). The alignment tool then automatically finds multimedia content that aligns with the course schedule, prioritizing results based on relative and/or absolute frequency of target language construction occurrences.

In one embodiment, the progress module 216 may track the progress of a user through learning a language, including tracking the amount of time spent viewing multimedia clips; multimedia clips that have been watched, re-watched, saved, and/or the like; different linguistic constructions that have been viewed, reviewed, learned, mastered, and/or the like; rewards, awards, trophies, and/or the like that have been earned; and/or the like.

Based on the user's progress, the machine learning module 210 may generate a personalized learning plan for the user. For instance, the machine learning module 210 may receive the user's inputs as it relates to the linguistic constructs that the user is studying and provide personalized recommendations, e.g., via the recommendation module 212 for language retention, learning, and challenging the user. In this manner the linguistic apparatus 104 creates a dynamic, personalized learning path for the user.

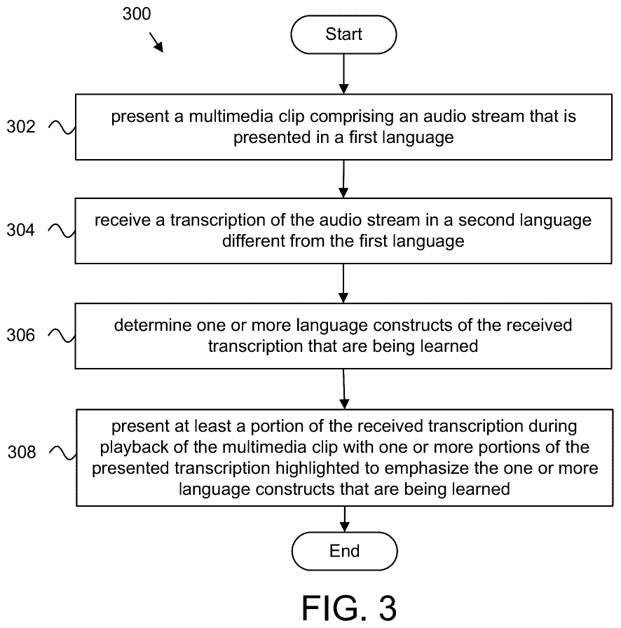

FIG. 3 depicts a flow chart diagram for one embodiment of a method 300 for language learning. In one embodiment, the method 300 may be performed by a linguistic apparatus 104, a multimedia module 202, a transcription module 204, a construct module 206, and/or a presentation module 208.

In one embodiment, the method 300 begins and presents 302 a multimedia clip comprising an audio stream that is presented in a first language. In one embodiment, the method 300 receives 304 a transcription of the audio stream in a second language different from the first language. In one embodiment, the method 300 determines 306 one or more linguistic constructions of the received transcription that are being learned. In one embodiment, the method 300 presents 308 at least a portion of the received transcription during playback of the multimedia clip with one or more portions of the presented transcription highlighted to emphasize the one or more linguistic constructions that are being learned, and the method 300 ends.

FIGS. 4A-4D depict one embodiment of an interface 400 for language learning. In FIG. 4A, in one embodiment, a multimedia clip 402 is presented within an interface (here, an interface of a smart device). The multimedia clip 402 may be a snippet of a movie or television show that contains an audio stream, e.g., dialogue, that illustrates one or more linguistic constructs that are being learned, tested, assessed, or the like.

In one embodiment, a transcription of the audio stream is presented 404 in the language of the audio stream. For example, if the audio stream is presented in English, the transcription 404 will also be shown in English. In one embodiment, the interface 400 includes a transcription 406 of the audio stream in a different language, e.g., the language being learned or assessed. Here, a Spanish transcription 406 of the English audio stream is presented. As shown in FIG. 4A, one or more parts (e.g., words) of the transcription 406 are highlighted or otherwise visually emphasized, indicating that parts can be interacted with, e.g., to see more information.

As shown in FIG. 4B, after the part “A ver” is selected, the presentation module 208 presents additional information for the selected part. In one embodiment, context information 408 is presented, such as a definition, use of the part in the context shown, and/or the like. An option may also be presented to present an audio pronunciation of the part. In one embodiment, expression information 410 is presented to explain how the selected part is typically used, what the typical meaning of the part is, and/or the like.

As shown in FIG. 4C, after the “Focus” button is selected, the interface presents the part 412 that was selected, the expression information 410, and additional resources for exploring the expression further, e.g., links to additional multimedia clips that illustrate usage of the part in context.

FIG. 4D illustrates an interface 450 for presenting the user's progress, rewards, trophies, reports, saved clips, viewed clips, and/or the like.

Means for performing the steps described herein, in various embodiments, may include one or more of an information handling device, a linguistic apparatus 104, a multimedia module 202, a transcription module 204, a construct module 206, a presentation module 208, a machine learning module 210, a recommendation module 212, a curriculum module 214, a progress module 216, a user's device, a mobile application, a network interface, a processor (e.g., a CPU, a processor core, an FPGA or other programmable logic, an ASIC, a controller, a microcontroller, and/or another semiconductor integrated circuit device), an HDMI or other electronic display dongle, a hardware appliance or other hardware device, other logic hardware, and/or other executable code stored on a computer readable storage medium. Other embodiments may include similar or equivalent means for performing the steps described herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus, comprising:
a processor; and
a memory that stores code executable by the processor to:
present a multimedia clip comprising an audio stream that is presented in a first language;
receive a transcription of the audio stream in a second language different from the first language;
determine one or more linguistic constructions of the received transcription that are being learned; and
present at least a portion of the received transcription during playback of the multimedia clip with one or more portions of the presented transcription highlighted to emphasize the one or more linguistic constructions that are being learned.

2. The apparatus of claim 1, wherein the code is executable by the processor to present additional information associated with at least one of the one or more highlighted portions of the presented transcription in response to user input.

3. The apparatus of claim 1, wherein the one or more linguistic constructions are selected from the group comprising morphology-based constructions, syntactic relation-based constructions, conjugation characteristics, parts of speech, alternatives, or a combination of the foregoing.

4. The apparatus of claim 1, wherein the code is executable by the processor to select the multimedia clip based on one or more linguistic constructions that are being learned.

5. The apparatus of claim 4, wherein the code is executable by the processor to use a linguistic construct query to determine one or more linguistic constructions that are being learned and the associated multimedia clips that illustrate usage of the one or more linguistic constructions.

6. The apparatus of claim 5, wherein the linguistic construct query acts upon one or more database structures to identify the one or more linguistic constructions that are being learned and the associated multimedia clips.

7. The apparatus of claim 5, wherein the code is executable by the processor to use a machine learning model to process the linguistic construct query to identify the one or more linguistic constructions that are being learned, the machine learning model comprising a neural network model.

8. The apparatus of claim 7, wherein the code is executable by the processor to initially train the machine learning model using referential sources and further refine the machine learning model using knowledge-based post-processing sources.

9. The apparatus of claim 1, wherein the code is executable by the processor to determine recommendations for one or more of a linguistic constructions to learn and a multimedia clip to present.

10. The apparatus of claim 1, wherein the code is executable by the processor to define linguistic constructions to be studied and identify multimedia clips illustrating the linguistic constructions.

11. A method, comprising:
presenting a multimedia clip comprising an audio stream that is presented in a first language;
receiving a transcription of the audio stream in a second language different from the first language;
determining one or more linguistic constructions of the received transcription that are being learned; and
presenting at least a portion of the received transcription during playback of the multimedia clip with one or more portions of the presented transcription highlighted to emphasize the one or more linguistic constructions that are being learned.

12. The method of claim 11, further comprising presenting additional information associated with at least one of the one or more highlighted portions of the presented transcription in response to user input.

13. The method of claim 11, wherein the one or more linguistic constructions are selected from the group comprising morphology-based constructions, syntactic relation-based constructions, conjugation characteristics, parts of speech, alternatives, or a combination of the foregoing.

14. The method of claim 11, further comprising selecting the multimedia clip based on one or more linguistic constructions that are being learned.

15. The method of claim 14, further comprising using a linguistic construct query to determine one or more linguistic constructions that are being learned and the associated multimedia clips that illustrate usage of the one or more linguistic constructions.

16. The method of claim 15, wherein the linguistic construct query acts upon one or more database structures to identify the one or more linguistic constructions that are being learned and the associated multimedia clips.

17. The method of claim 15, further comprising using a machine learning model to process the linguistic construct query to identify the one or more linguistic constructions that are being learned, the machine learning model comprising a neural network model.

18. The method of claim 17, further comprising initially training the machine learning model using referential sources and further refining the machine learning model using knowledge-based post-processing sources.

19. The method of claim 11, further comprising determining recommendations for one or more of a linguistic constructions to learn and a multimedia clip to present.

20. An apparatus, comprising:
means for presenting a multimedia clip comprising an audio stream that is presented in a first language;
means for receiving a transcription of the audio stream in a second language different from the first language;
means for determining one or more linguistic constructions of the received transcription that are being learned; and
means for presenting at least a portion of the received transcription during playback of the multimedia clip with one or more portions of the presented transcription highlighted to emphasize the one or more linguistic constructions that are being learned.
